(19) United States
(12) Patent Application Publication
(10) Pub. No.: US 2006/0017958 A1
(43) Pub. Date: Jan. 26, 2006

(54) Printer method and system

(76) Inventors: Lee Walter Jackson, Vancouver, WA (US); Jefferson P. Ward, Brush Prairie, WA (US); Joseph H. Bauman, Brush Prairie, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/897,765

(22) Filed: Jul. 23, 2004

(51) Int. Cl. G06K 15/00; G06F 3/12

(52) U.S. Cl. 358/1.14; 358/1.15

(57) ABSTRACT

A printer receives commands from a host device in association with a print request, determines if the printer's resources permit processing of the commands received from the host when in a non-discard mode, enters the printer into a discard mode when resources associated with the printer are not available to permit processing the commands and, unless a command is protocol control command, discards commands to maintain communication between the printer and the host. The printer exits discard mode when a command received from the host is a protocol control command requesting that the printer exit discard mode. The host buffers commands associated with the print request, transmits commands to the printer for printing, receives indication that the printer is entering into a discard mode and resends the commands buffered on the host to the printer when the printer indicates it has exited discard mode.

### BACKGROUND OF THE INVENTION

Printers are designed to work in a variety of computing environments. Generally, the printer is attached to a computer host and receives files for printing from the host over a communication channel in accordance with one or more printer communication protocols. Conventional printer communication protocols facilitate several different types of communication between a host and the printer using one or more different types of “commands.” These commands can be divided into “protocol control commands” and “device commands.” Protocol control commands are a subset of the commands used by the host and the printer to control the flow of commands and print data when using the printer communication protocol. Device commands are all the other types of commands other than “protocol control commands” as used by the host and printer when implementing a printer communication protocol.

Device commands can be further divided into “print commands” used to accomplish the actual printing and “printer status and control commands” (hereinafter “printer control commands”). Upon execution, the print commands typically require significant resources on the printer (e.g., paper, ink, other consumables and computational resources) as they require the printer to print data on paper or another medium. In contrast, the printer control commands use nominal computational resources and little or no consumables or other resources typically used by the print commands. As a group, printer control commands take care of one or more features or operations on the printer or host device that affect the printed output or operation. For example, printer control commands in a conventional printer communication protocol may be used to control general operation of the printer (i.e., change the print quality of a printer, select a paper tray for printing or even cause a printer to load a particular font into printer memory) and check status of current or pending print jobs.

On more economical printers, a single bidirectional physical communication channel carries all commands between the host and printer “in-band” using multiple logical channels. In-band means a single physical communication link carries all information between host and printer. The single bidirectional physical communication channel is less expensive than using multiple physical communication channels.

Because the data is traveling over the same physical link, printers and hosts communicate data and commands back and forth using multiple logical channels implemented using an additional multiple logical channel protocol (MLC protocol). The MLC protocol is used in addition to the conventional printer protocol and facilitates communication over the same physical link by dividing the physical link into separate channels of information. By separating the one physical bidirectional link into several logical channels, the printer and host are capable of exchanging several logically independent streams of commands over the same physical link. For example, one channel can be used by the host and printer to exchange protocol control commands while another channel is used to exchange device commands.

Printer and host communication using conventional printer protocols often require the several logical channels offered by the MLC protocol. For example, if the printer becomes busy and cannot process more device commands over one channel then the host can still communicate printer control commands to the printer over the alternate channel. Without the MLC protocol, a printer implementing conventional printer protocols would likely experience frequent deadlocks when communicating with the host.

In addition to the conventional printer protocol and MLC protocol, printers and hosts may also be required to support and use several other protocols related to printing. Page description languages are a type of protocol used to describe the layout of information to be printed by the printer. For example, Printer Control Language or PCL is one page description language that not only describes the layout or format of information to be printed by the printer but also includes a limited set of commands related to controlling the printer. PostScript is another page description language also used to describe the layout of information to be printed by the printer. Unlike PCL, PostScript is used to layout information for printing but typically is not used to control other aspects of the printer like PCL.

Even status information between the printer and the host may be managed by a separate protocol. Printer management language (PML) carries status and control information between the host and the printer during the printing process to keep the host, printer and user apprised of the printing status. For example, PML can be used by the printer to notify the host that the printer is out of paper and needs more paper to continue printing. The additional PML protocol requires allocation of additional storage, specialized device drivers and processing on both the host and the printer.

These numerous printer protocols and drivers used in conventional printer protocol communication make it difficult to develop low cost printers. Each of the protocols described above increase the memory requirements in the printer. Printer processing requirements are also increased as operation and management of these protocols in the printer may require greater computational power. Yet many printer manufacturers continue to use the various protocols as the legacy drivers are already developed and integrated with popular operating systems like Windows and the MacOS.

Unfortunately, eliminating one or more of these printing protocols may not be possible without significant drawbacks. Conventional hosts and printers without MLC or MLC-like protocols may not operate properly as the printer related data may not flow efficiently over a single channel. The single channel may become overwhelmed or “clogged” with data during printing or other input-output operations due to one or more exception conditions. For example, a printer may block the single channel and not accept additional input if it is does not have the resources to process additional print commands. The blocked channel in turn may prevent the host from sending commands to clear the blocked channel condition resulting in an undesirable deadlock between the host and the printer.

Printer problems are also common when the native operating system on the host does not come loaded with the necessary drivers and input-output stack used by the printer. Many issues can arise while attempting to load and configure the drivers and input-output stack required by the printer as each operating system often has different loading and configuration requirements. Further problems may arise due to incompatibilities with other installed applications and drivers. These problems are even more difficult to predict and resolve as they depend not only on operating system differences but on various combinations of applications loaded under the operating system.

Problems may also arise even when the native operating system includes the various drivers and input-output stack specified by the printer. Initial device drivers and input-output stacks may not be compatible with later releases or versions of software on the host or printer. Protocols may differ slightly from one release or version to the next causing problems with the host, the printer or both. These problems may be subtle and difficult to identify and debug. While some versions of the device drivers or protocols may work together for one printer and host, the same combination of device drivers generally do not work with a different printer and host combination.

For at least the aforementioned reasons, an improved printer protocol is needed to allow for the development and operation of lower cost, more efficient and reliable printers.

### BRIEF DESCRIPTION OF THE DRAWINGS

FIG. 1 is a block diagram of a system for printing on a printer attached to a host in accordance with one implementation of the present invention;

FIG. 2 is a block diagram illustrating aspects of a printer communication protocol designed in accordance with implementations of the present invention;

FIG. 3 is a flowchart diagram of the operations for a printer to communicate using a non-blocking printer protocol (NBPP) designed in accordance with implementations of the present invention;

FIG. 4 provides a corresponding flowchart diagram of the operations that a non-blocking printer protocol (NBPP) performs on a host in accordance with implementations of the present invention; and

FIG. 5 is a block diagram of a printer system designed in accordance with implementations of the present invention.

Like reference numbers and designations in the various drawings indicate like elements.

### SUMMARY OF THE INVENTION

One aspect of the present invention features a method and system for a printer to communicate with a host. The communication includes receiving commands compatible with a printer protocol from the host to be processed on the printer in association with a print request, determining if one or more resources associated with the printer permit processing of the commands received from the host when the printer is in a non-discard mode, entering the printer into a discard mode when the determination indicates the one or more resources associated with the printer are not available to permit processing of the commands and, unless a command is a protocol control command used by the host and printer to control the communication between the host and printer, discarding one or more of the commands to maintain communication between the printer and the host and exiting the printer from the discard mode and entering into a non-discard mode when at least one of the commands received from the host is a protocol control command requesting that the printer exit discard mode and process the commands received instead of discarding the commands received.

Another aspect of the present invention features a method and system for a host to communicate with a printer. The host communicates by buffering commands associated with a print request on the host, transmitting commands associated with the print request to the printer for printing, receiving indication that the printer is entering into a discard mode to maintain communication between the printer and the host when the printer determines one or more resources associated with the printer are not sufficient to process the commands associated with the print request and resending the commands buffered on the host to the printer when the printer indicates it has exited discard mode and entered non-discard mode.

### DETAILED DESCRIPTION

Aspects of the present invention are advantageous in at least one or more of the following ways. Embodiments of the present invention can be readily implemented without significant modification to the operating system or kernel running on the host. Instead of using multiple layers and protocols, a single level printer communication protocol manages the printer communication over a single bidirectional channel between the host and the printer. Unlike conventional solutions, this single level driver effectively communicates data, status and control between the host and the printer over a single bidirectional channel without the need for multiple logical channels.

Implementations of the present invention are also advantageous as they are able to use a single driver rather than multiple drivers or protocols to communicate between the printer and the host. Smaller and less complicated drivers are possible when the multiple protocols are eliminated in lieu of a single level protocol used on both the host and printer. This reduces the required number of drivers for both the printer and host to operate and the complexity for developing and maintaining the code base.

In addition, implementations of the present invention discards selected commands to keep the communication between the host and printer open. This ensures that host can communicate with the printer even when the printer is busy or certain resources associated with the printer become unavailable. Further details on discarding commands in accordance with the present invention are provided in further detail later herein.

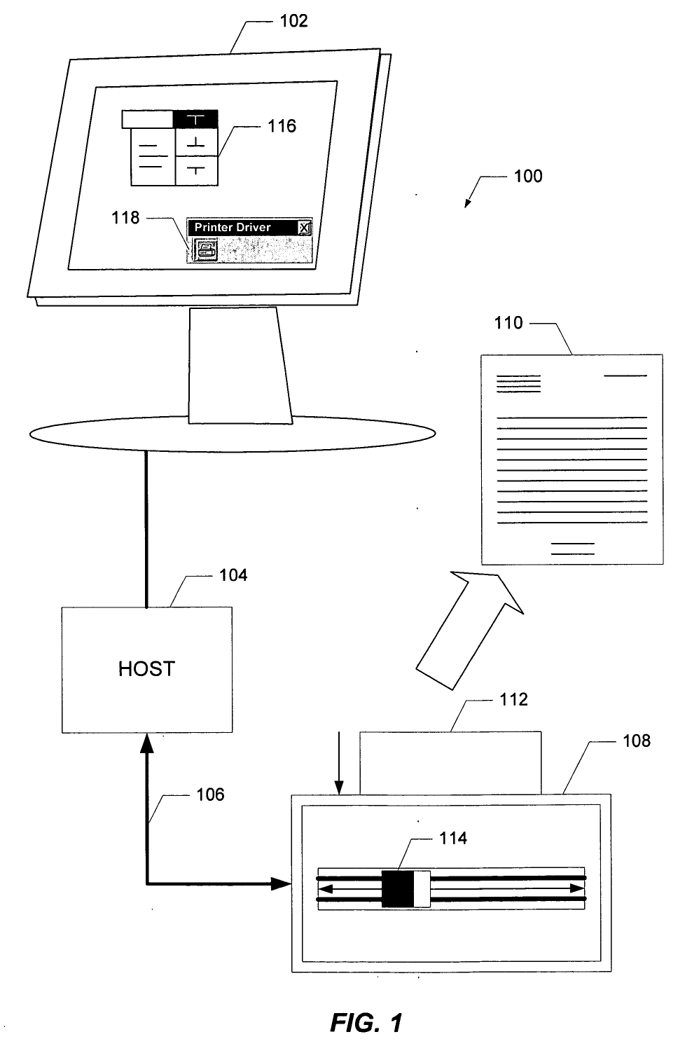

FIG. 1 is a block diagram of a system for printing on a printer attached to a host in accordance with one implementation of the present invention. System 100 includes a display device 102, a host 104, a bidirectional communication path 106, a printer 108, printed output 110 and a print medium 112. In operation, a request to print is received and processed on host 104 for printing on printer 108. Host 104 and printer 108 implement a printer communication protocol to communicate commands and print data with each other used for printing and related functions. Print data is the actual data to be printed by the printer.

The printer protocol designed in accordance with implementations of the present invention facilitates several different types of communication between the host and the printer using one or more different types of “commands.” As previously described, these commands can be divided into “protocol control commands” and “device commands.” Protocol control commands are a subset of the commands used by the host and the printer to control the flow of commands and print data when using the printer communication protocol. Device commands are all the other types of commands other than “protocol control commands” as used by the host and printer when implementing the printer communication protocol.

Device commands can be further divided into “print commands” used to accomplish the actual printing and “printer status and control command” (hereinafter “printer control command”). Upon execution, the print commands typically require significant resources on the printer (e.g., paper, ink, and other consumables) as they require the printer to print data on paper or another medium. In contrast, the printer control commands use nominal computational resources and little or no consumables or other resources typically used by the print commands. As a group, printer control commands take care of one or more features or operations on the printer or host device that affect the printed output or operation. For example, printer control commands in a conventional printer communication protocol may be used to control general operation of the printer (i.e., change the print quality of a printer, select a paper tray for printing or even cause a printer to load a particular font into printer memory) and check status of current or pending print jobs.

Many of the printer control buttons and status indicators found on conventional printers are instead displayed on display device 102 to reduce the costs of integrating buttons and other control mechanisms on printer 108. In one implementation, the printer controls and status information are displayed on display device 102 using a printer control window 116 and a printer status icon 118 respectively. Printer control window 116 displays one or more control buttons for controlling printer 108 and printer status icon 118 displays the current status of printer 108. For example, printer status icon 118 may indicate the printer is currently printing, out of paper, or needs toner.

Accordingly, printer 108 exchanges print data, printer control commands and status information with host 104 over bidirectional communication path 106. A user not only views print job progress in printer control window 116 but can also be prompted to attend to various maintenance and error conditions typical during printing. For example, printer control window 116 can be used to prompt the user to load additional paper, change an ink or laser cartridge, clear a paper jam in printer 108 or any other maintenance or error operation used to facilitate the continued printing of one or more print jobs. Further, printer status icon 118 may provide a flashing indicator to notify the user that the print job or jobs need attention and to open printer control window 116.

As the above described operations occur, one or more internal communications between host 104 and printer 108 may also occur. For example, if an error or maintenance operation is performed then a “continue” type command may be communicated to the printer from the host indicating that the printer should continue or at least attempt to continue printing the one or more print jobs in the queue. Host 104 and printer 108 implementing aspects of the present invention can rely on communicating this type of information using a single channel rather than using the multiple logical channels provided by a MLC protocol over the bidirectional physical channel.

In general, the single channel remains open and available to protocol control commands by discarding print commands when they can not be executed due to low or unavailable resources on the printer. Print commands are discarded as they typically require significant resources from the printer (e.g., paper, ink, other consumables and computational resources). Other commands like printer control commands are not discarded as they use nominal computational resources and little or no consumables from the printer when they are executed. As will be explained and described in further detail in accordance with implementations of the present invention, it is important to execute protocol control commands sent from the host to the printer as they help keep the printer available for printing even when the various resources on the printer may get low or unavailable.

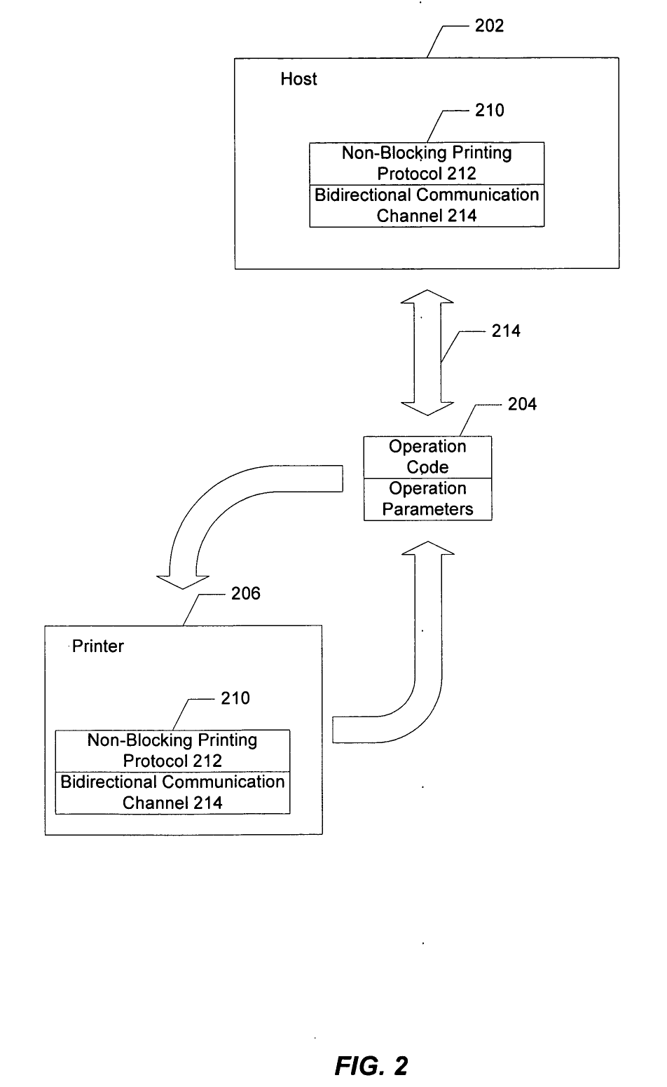

Referring to FIG. 2, a block diagram illustrates aspects of a printer protocol designed in accordance with implementations of the present invention. This example illustration includes a host 202 communicating with a printer 206 using a non-blocking printer protocol (NBPP) 212 designed in accordance with implementations of the present invention. In one implementation, printer 206 transmits NBPP command 204 over bidirectional communication channel 214 to host 202. The NBPP 212 is one example of a single level protocol capable of performing the requisite printer communications over a single communication channel rather than a multiple logical channel (MLC) protocol. NBPP 212 keeps information over bidirectional communication channel 214 moving by not completely blocking the data flow thus obviating the need for conventional MLC protocols and techniques. Instead of blocking the data flow between host 202 and printer 206, printer 206 only accepts certain commands for processing and discards the rest of the commands. Even so, the discarded commands are not lost but buffered on host 202 and later resent to printer 206 when printer 206 has the available resources to process the previously discarded commands.

In one implementation, printer 206 and host 202 generates a stream of NBPP command 204 on bidirectional communication channel 214 containing commands compatible with the printer protocol designed in accordance with implementations of the present invention. As previously described, each of the commands used in the printer protocol are divided into several different categories. In one implementation, the stream of NBPP commands 204 include 1) protocol control commands used for controlling the protocol, 2) print commands and 4) printer status and control commands. Each of these types of commands may or may not be discarded in order to keep the communication channel between host 202 and printer 206 available. In general, protocol control commands are not discarded even when printer 206 is in discard mode.

Printer 206 receives the stream of NBPP command 204 and begins processing the commands in accordance with the particular functionality requested on printer 206. For example, printer 206 parses each NBPP command 204 for an operation code and operation parameters. In accordance with one implementation, printer data in the NBPP command 204 are printed onto the output medium in accordance with formatting and other printer requirements (e.g., PCL, PostScript or other page description languages).

A protocol control command in NBPP command 204, as described previously, is used to control the communication between host 202 and printer 206 using the protocol. In one implementation, the protocol control commands include a “discard notification” command sent from the printer to the host indicating discard is going to occur on the printer and a complimentary “stop discard” protocol control command sent from the host to the printer indicating that the printer should stop discarding. When printer 206 is in a discard mode, commands other than protocol control commands sent from the host to the printer are discarded as previously described.

If resources on printer 206 are low or unavailable, printer 206 does not block communication but continues to receive NBPP command 204. In one implementation of the present invention, a printer receiving NBPP command 204 under these conditions discards device commands to keep bidirectional communication channel 214 open but continues to process protocol control commands. By discarding selected NBPP commands 204, the channel remains open and available for the more important commands in the NBPP protocol.

This arrangement enables the host to send a “stop discard” protocol control command to a printer in discard mode and subsequently have the printer receive printer control commands over bidirectional communication channel 214. As previously described, the printer control commands are a subset of device commands and are discarded when the printer has entered discard mode. Printer control commands do not cause the printer to enter back into discard mode as they typically gather status on the printer but, like protocol control commands, use only nominal computational resources and little or no consumables.

Communication is effectively ensured by selectively discarding certain NBPP command 204 thus keeping the channel open even while the printer may be busy printing another print job. Host 202 later resends buffered copies of the discarded commands to printer 206 once printing or other function causing the busy condition no longer exists or has been overcome through user intervention.

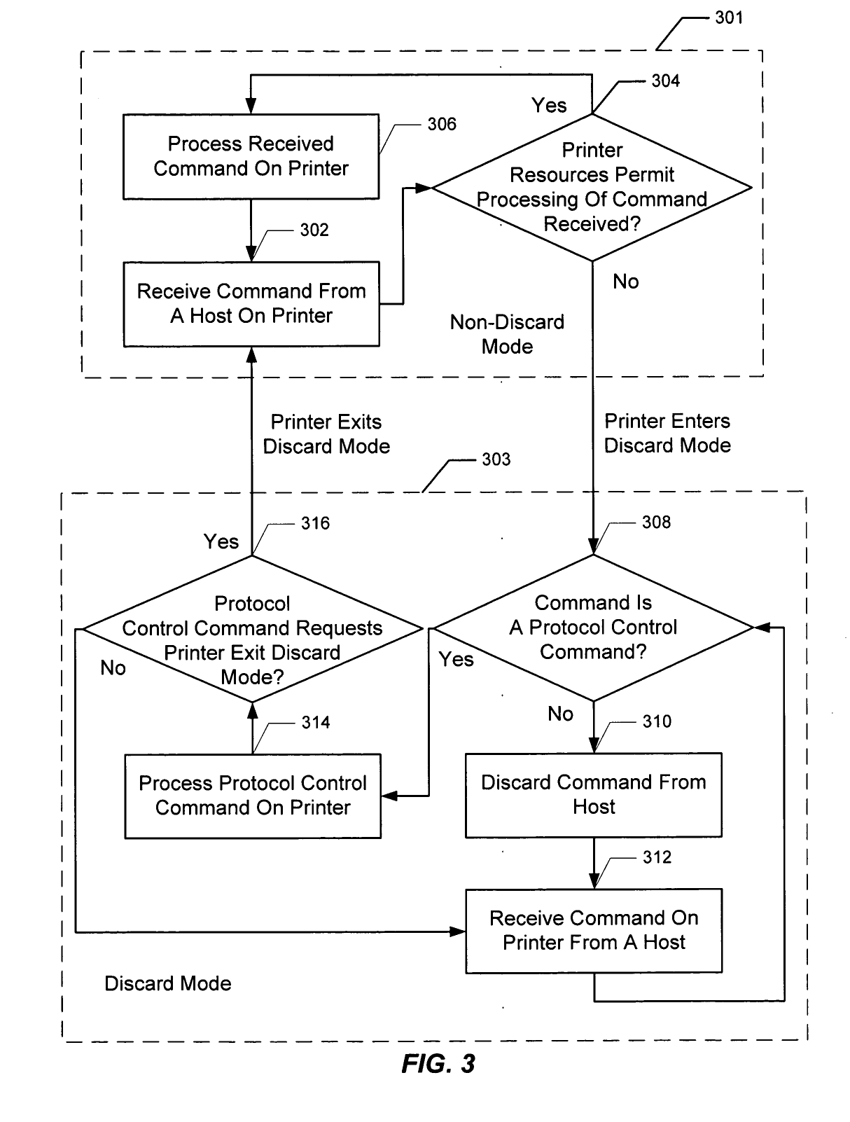

FIG. 3 is a flowchart diagram of the operations for a printer to communicate using a non-blocking printer protocol (NBPP). Printers operate in accordance with implementations of the present invention in either a discard mode (301) or a non-discard mode (303). A printer initially starts in a non-discard mode (301) as it is assumed that the printer has sufficient resources to print a submitted print job. Later, if the printer determines or discovers the resources associated with the printer are too low or insufficient to process a submitted print job from a host then the printer enters into a discard mode (303). Once the resources are related or replenished, then the printer enters back into non-discard mode (301) in accordance with implementations of the present invention.

Referring to FIG. 3, the printer begins in non-discard mode (301) and receives a command from a host (302). In most cases, a host device or computer operates as a master device while the printer operates as a slave device in an asymmetric printer protocol implementation of the present invention. Alternatively, both the host device and printer may operate as peers in a symmetric or peer-to-peer protocol implementation of the present invention.

In non-discard mode (301), the printer determines if the printer resources permit processing of the command received (304). In one implementation of the present invention, the printer determines if it has sufficient paper, toner, ink, memory, or is operating properly to fulfill a print request. For example, relevant resources on a printer include available memory or storage, processor capabilities, toner or ink capacity, communication bandwidth between the printer and a host or any other resource that affects printing. Moreover, the printer needs adequate bandwidth to carry the printer data and commands associated with controlling the printer protocol and sufficient processing capabilities on the printer to print the print request. Because printer configurations are often quite different, a printer may use a heuristic or other statistical method to determine whether resources available on the printer are sufficient to complete the print request.

In the event the printer has sufficient resources, the printer remains in non-discard mode and processes the received command on the printer (306). For example, processing the command received on the printer may cause the printer to print data on paper or other print mediums. In general, the printer processes all types of commands when in non-discard mode including protocol control commands and device commands or any other commands in a NBPP protocol.

Alternatively, the printer operating in non-discard mode (301) may instead determine there are insufficient resources or the resources are too low to process the command received from the host (304). If this occurs, the printer enters discard mode (303). Typically, the printer does not enter discard mode unless the print engine is in an “unable to print” state. There can be numerous causes for entering an unable to print state including: out of paper, print cartridge problem, door open, paper jammed, carriage blocked and other similar problems. In accordance with this implementation, the printer's inability to print is an objective measure of not being able to execute a command transmitted from the host. Developing this objective measure advantageously keeps the channel open while limiting the chance the printer will enter discard mode unnecessarily or in cases that would be detrimental to the overall printing process.

As will be described in further detail later herein, one implementation of the present invention implemented keeps a circular first-in-first-out (FIFO) buffer of previously transmitted commands and data on the host until the host knows the commands and/or data has been successfully processed by the printer. By continuously buffering data on the host, commands sent from the host after the printer enters discard mode are not lost in the interim period preceding the host's actual discard notification from the printer.

The printer notifies the host to continue buffering data and, in one implementation, specifies to the host the last successfully executed command before the printer began discarding. The host then releases from the buffer any data prior to the last successfully executed command and continues to buffer the subsequent data actively being discarded by the printer. The host notes the last successfully executed command in the buffer as the point where to restart data retransmission after the condition causing the printer to enter discard mode has been removed or alleviated. Instead of notifying the host of the last command successfully processed, an alternate implementation of the present invention may indicate the particular time the printer began discarding. In either approach, the printer notifies the host when discard began so the host can make sure to buffer and later resend the discarded commands.

In discard mode (303), the printer first determines if the command is a protocol control command (308). As previously described, the printer does not discard protocol control commands even when the printer is in discard mode (303). The protocol control commands ensure the host can communicate with the printer even when the printer is in discard mode (303). However, any other type of command received other than a protocol control command is discarded (310) and the printer prepares to receive the next command (312) while in the context of being in discard mode (303).

In the event the command is a protocol control command, it is not discarded but is instead processed by the printer (314). Implementations of the present invention also determine what type of protocol control command has been transmitted from the host to the printer. If the protocol control command does not request that printer exit discard mode (316) then the printer merely processes the protocol control command, performs one or more functions associated with the protocol control command and then continues to evaluate subsequent commands for processing while remaining in discard mode (303)

If the printer control command does request the printer exit discard mode (316) then the printer shortly thereafter returns to the non-discard mode (301). It should be understood that the host expects that the event that caused the printer to originally enter discard mode (303) has been addressed or is no longer of a concern. For example, the host usually sends a “stop discard” protocol control command immediately upon receiving the discard notification from the printer. The host assumes that the user or the printer itself has cleared a condition and released sufficient resources to process the requested command. In the event the resources continue to remain low or unavailable, the printer may re-enter discard mode (301) and repeat the previously described operations.

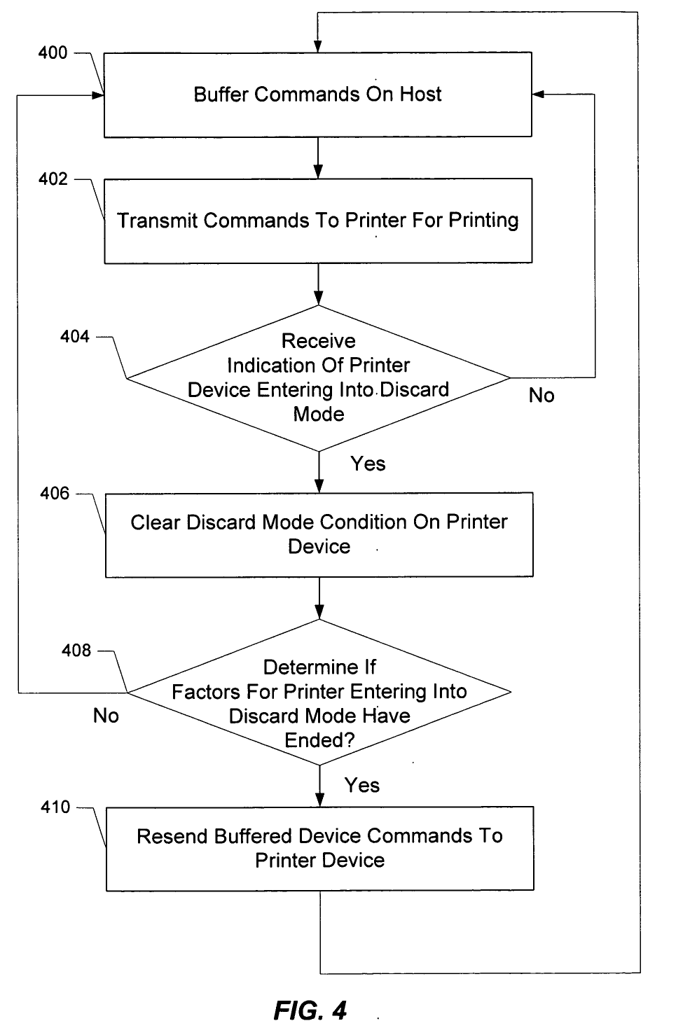

FIG. 4 provides a corresponding flowchart diagram of the operations taking place on the host in accordance with implementations of the present invention. Initially, the host buffers commands (400). The host keeps a buffer filled with the most recently transmitted commands until it is clear that the printer has successfully received and processed the transmitted commands. For example, the host uses a circular FIFO buffer to hold commands sent to the printer in case the printer enters discard mode in accordance with the present invention. In one implementation, the host presumes the printer receiving the commands can process the information rapidly and therefore transmits the information at the highest possible rate over the bidirectional communication channel. Alternate implementations of the present invention test the processing characteristics of the printer and then transmit the commands at a rate commensurate with the printers' processing capabilities based on stochastics. In either implementation, the host continues to transmit commands to the printer (402). It should be appreciated that the host buffers data and transmits commands to the printer when the printer is in both non-discard mode as well as when in discard mode.

At one or more time intervals during the printing, the host may receive notification that the printer is entering into discard mode (404). As previously described, the printer enters discard mode when the printer determines there are insufficient resources or the resources are too low to process the command received from the host. By entering into discard mode, the printer begins discarding all but the protocol control commands and defers printing the print data in accordance with implementations of the present invention.

The host may use a portion of the commands already stored in the buffer prior to the notification for later retransmission. For example, several commands already buffered on the host and transmitted from the host to the printer may have been discarded by the printer before the host received notice of the printer entering into discard mode. In one implementation of the present invention, the host determines the portion of the buffered commands to store (and eventually retransmit) according to the last successfully executed command as indicated by the printer.

Over the course of printing the print request, the host continues to send commands to the printer. As previously described, however, if the printer is in printer discard mode then the device commands consisting of both the print commands and printer control commands are discarded upon receipt at the printer. In contrast, the protocol control commands are not discarded whether or not the printer is in discard or non-discard modes.

As previously described, the host immediately attempts to clear the discard mode condition on the printer (406). In one implementation of the present invention, the host sends a “stop discard” command from the set of protocol control commands to make the printer enter back into non-discard mode. Unlike other commands, the “stop discard” command and other commands in the set of protocol control commands are not discarded even though the device may already be in discard mode. In particular, when the host receives the “discard notification” from the device, it will immediately send the “stop discard” protocol control command to the printer so that the host can attempt to resolve the printer condition quickly and resume printing and other functions as soon as possible.

Once the printer has re-entered non-discard mode, the host also has the option of sending printer control commands that use nominal printer resources and therefore unlikely to put the printer back into discard mode. For example, printer control commands sent by the host may include a status inquiry command to determine the status of the printer. Typically, the status inquiry command is executed by the printer using nominal computational resources. The status results are then provided back to the host for analysis and resolution. For example, the status inquiry command may read certain register values on the printer and return the results to the host to determine if the condition that previously caused the printer to enter discard mode has been cleared. If the condition that caused the printer to enter discard mode remains in effect, the printer may delay sending device commands or other commands that require printer resources and could cause the printer to re-enter discard mode.

After checking the printer status one or more times, the host may attempt to clear the condition that caused the printer to initially enter discard mode. In one implementation, the printer sends a printer control command called a “continue” command. While in non-discard mode, the continue command is transmitted from the host to the printer and in some cases is capable of clearing an “unable to print” condition on the printer due to low or unavailable resources. For example, if an out of paper condition is indicated the host can issue the continue command and attempt to make the printer to try to pick a sheet of paper available on the printer.

Eventually, the host determines that the factors for the printer entering into discard mode have ended (408). The host determines when it is appropriate to begin sending print commands again by analyzing the status information gathered using one or more status inquiry commands. For example, the host may analyze the status information returned indicating that a user has loaded additional paper, changed an ink or laser cartridge, cleared a paper jam in printer or resolved any other condition that might have previously caused the printer to enter discard mode.

When the host believes that the condition that caused the printer to enter discard mode has been resolved, it resends buffered print commands to the printer (410) with the expectation that the printer will not re-enter discard mode as result. Once again, the host does not remove a command from the buffer until the printer confirms that the command has been successfully executed. This ensures that no command is lost in the event the printer immediately reenters into the discard mode.

Otherwise, if the host determines that the conditions for printer discard mode are still in place, the host continues to buffer device commands (400) and does not resend buffered commands to the printer. If the discard mode conditions persist, the host may automatically increase the buffers used to buffer the device commands being discarded by the printer. For example, the host may increase the buffer size on the host using a special cache or carving additional storage in main memory large enough to buffer all commands discarded while the printer continues to operate in discard mode.

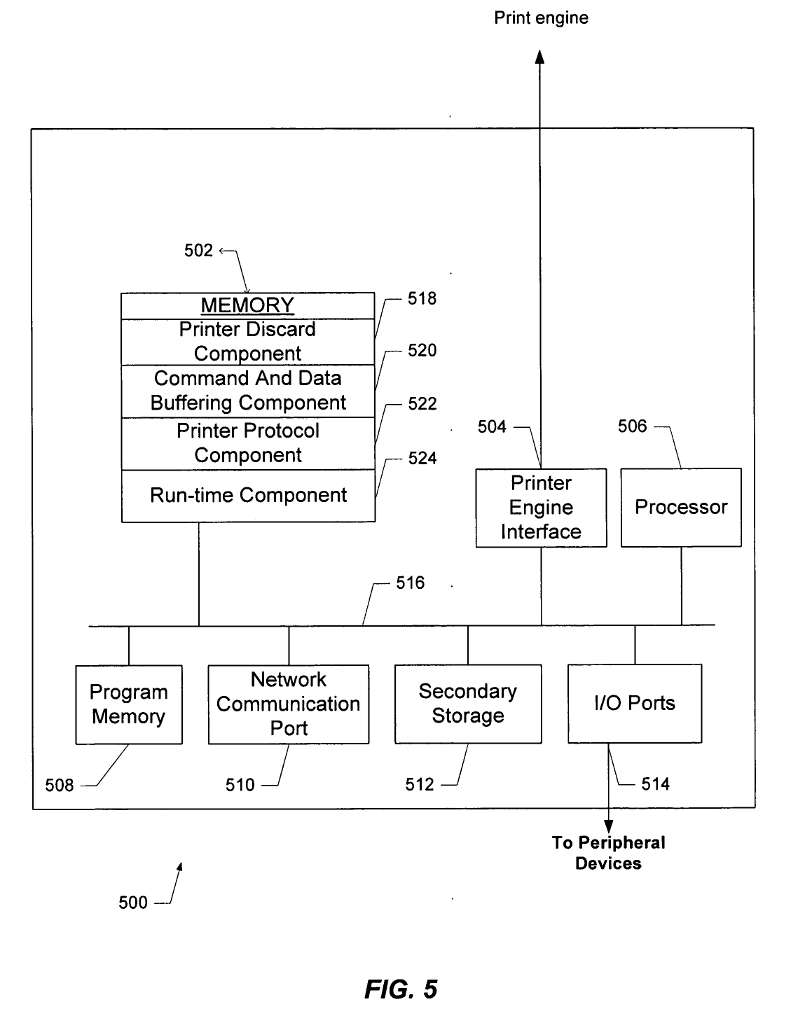

FIG. 5 is a block diagram of a printer control system 500 (hereinafter system 500) used in one implementation for performing the apparatus or methods of the present invention. System 500 includes a memory 502 (typically random access memory (RAM) or read-only memory (ROM) such as a flash ROM) to hold executing programs, a printer engine interface 504 capable of interfacing and driving a print engine used in a printer or other similar device, a processor 506, a program memory 508 for holding drivers or other frequently used programs, a network communication port 510 for data communication, a secondary storage 512 with a secondary storage controller and input/output (I/O) ports 514 with a controller operatively coupled together over an interconnect 516. System 500 can be preprogrammed, in ROM, for example, using field-programmable gate array (FPGA) technology or it can be programmed (and reprogrammed) by loading a program from another source (for example, from a floppy disk, a CD-ROM, or another computer). Also, system 500 can be implemented using customized application specific integrated circuits (ASICs).

In one implementation, memory 502 includes a printer discard component 518, a command and data buffering component 520, a printer protocol component 522 and a run-time component 524 that manages system resources used when processing one or more of the above components on system 500.

As illustrated, these various components of the present invention appear in a single computer system or computer based printer. However, alternate implementations could also distribute these components in one or more different computers, host devices or printers to accommodate for processing demand, scalability, high-availability and other design constraints. In a peer-to-peer implementation, each host and printer includes each of the aforementioned components to implement the present invention. For example, system 500 necessarily includes components used on a host and components used on a printer for purposes of discussion as well as to simplify describing one possible implementation, Depending on the implementation, the host would use those components suitable for the host while the printer would use those components in FIG. 5 to be used on the printer. Instead of implementing in a peer-to-peer arrangement, an alternate implementation described in further detail previously, implements one or more components of the present invention with the host as a master device and printer as a slave device.

Referring to FIG. 5, printer discard component 518 is responsible for determining when a printer needs to discard commands in accordance with an embodiment of the present invention. As each command is received, the printer discard component 518 determines if the resources on the printer are not available or too low to process the command transmitted from a host. If the printer does not have the resources to execute the command then printer discard component 518 causes a printer to enter into discard mode as previously described.

Command and data buffering component 520 performs buffering of device commands on a host device to be sent later to a printer. The command and data buffering component 520 stores the commands in a storage area associated with the host device and sends the commands onto the printer as appropriate. As previously described, only the protocol control commands are executed by the printer when the printer is in discard mode. When appropriate, command and data buffering component 520 also resends the buffered commands to the printer for subsequent processing and/or printing.

Printer protocol component 522 is a single level printing protocol that sends commands using a non-blocking printer protocol (NBPP) designed in accordance with implementations of the present invention. The commands sent using printer protocol component 522 of the present invention keeps the bidirectional communication channel between the host and the printer open. Embodiments of the present invention keep the communication channel open between the host and printer rather than blocking the communication channel until the printer is ready to continue printing. By not blocking the channel, printer protocol component 522 is able to transmit print commands and printer control commands using a single channel rather than the multiple channels used by conventional printer protocols using an MLC or MLC-like protocol.

While examples and implementations have been described, they should not serve to limit any aspect of the present invention. Accordingly, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

While specific embodiments have been described herein for purposes of illustration, various modifications may be made without departing from the spirit and scope of the invention. For example, implementations of the present invention expressly or implicitly described as being used with ink jet technologies may be equally applied to laser jet printing technologies. Accordingly, the invention is not limited to the above-described implementations, but instead is defined by the appended claims in light of their full scope of equivalents.

What is claimed is:

1. A method for a printer to communicate with a host, comprising:
receiving commands compatible with a printer protocol from the host to be processed on the printer in association with a print request;
determining if one or more resources associated with the printer permit processing of the commands received from the host when the printer is in a non-discard mode;
entering the printer into a discard mode when the determination indicates the one or more resources associated with the printer are not available to permit processing of the commands and, unless one of the commands received is a protocol control command used by the host and printer to control the communication between the host and printer, discarding one or more of the commands to maintain communication between the printer and the host; and
exiting the printer from the discard mode and entering back into a non-discard mode when one of the commands received from the host is a protocol control command requesting that the printer exit discard mode.

2. The method of claim 1 wherein the received commands include: protocol control commands used by the host and printer to control the communication between the host and printer using the printer protocol that are not discarded by the printer when in a discard mode, print commands used to accomplish the actual printing on the printer that are discarded when the printer is in a discard mode and printer control commands that affect how one or more features on the printer operates when printing and that are discarded when the printer is in a discard mode.

3. The method of claim 1 wherein the commands received on the printer are carried over a bidirectional communication channel.

4. The method of claim 1 wherein determining if the one or more resources permit processing further includes determining if the printer processing the commands has sufficient amounts of resources selected from a set of one or more resources including:
paper, toner, ink, storage, computational capacity, and communication bandwidth between the printer and a host.

5. The method of claim 1 further comprising,
indicating to the host the last executed command before the printer enters into discard mode and begins to discard commands.

6. The method of claim 1 further comprising,
downloading the discarded one or more commands from a buffer on the host to the printer to complete processing of the print request when the printer exits discard mode and enters non-discard mode.

7. The method of claim 5 wherein the host transmits the protocol control command in response to the indication that the printer has entered into discard mode indicating the printer should exit discard mode and begin processing the commands being received instead of discarding the commands received.

8. A method for a host to communicate with a printer, comprising:
buffering commands associated with a print request on the host;
transmitting commands associated with the print request to the printer for printing;
receiving indication that the printer is entering into a discard mode to maintain communication between the printer and the host when the printer determines one or more resources associated with the printer are not sufficient to process the commands associated with the print request; and
resending the commands buffered on the host to the printer when the printer indicates it has exited discard mode and entered non-discard mode.

9. The method of claim 8 wherein the transmitted commands include: protocol control commands used by the host and printer to control the communication between the host and printer using the protocol that are not discarded by the printer when in a discard mode, print commands used to accomplish the actual printing on the printer that are discarded when the printer is in a discard mode and printer control commands that affect how one or more features on the printer operates when printing and that are discarded when the printer is in a discard mode.

10. The method of claim 8 wherein the commands are transmitted by the host over a bidirectional communication channel

11. The method of claim 8 wherein the one or more resources associated with the printer are selected from a set of one or more resources including: paper, toner, ink, storage, computational capacity, and communication bandwidth between the printer and a host.

12. The method of claim 8 wherein the host transmits a protocol control command in response to the indication that the printer has entered into discard mode, wherein the protocol control command indicates that the printer exit discard mode and process the commands transmitted instead of discarding the commands transmitted.

13. The method of claim 8 wherein resending the commands buffered on the host facilitates completing the print request.

14. An apparatus for a printer to communicate with a host, comprising:
a processor capable of executing instructions;
a memory containing instructions when executed causes the processor to receive commands compatible with a printer protocol from the host to be processed on the printer in association with a print request, determine if one or more resources associated with the printer permit processing of the commands received from the host when the printer is in a non-discard mode, enter the printer into a discard mode when the determination indicates the one or more resources associated with the printer are not available to permit processing the commands and, unless a one of the commands received is a protocol control command used by the host and printer to control the communication between the host and printer, discard one or more of the commands to maintain communication between the printer and the host and exit the printer from the discard mode and entering into a non-discard mode when at least one of the commands received from the host is a protocol control command requesting that the printer exit discard mode and process the commands received instead of discarding.

15. The apparatus of claim 14 wherein the received commands include: protocol control commands used by the host and printer to control the communication between the host and printer using the printer protocol that are not discarded by the printer when in a discard mode, print commands used to accomplish the actual printing on the printer that are discarded when the printer is in a discard mode and printer control commands that affect how one or more features on the printer operates when printing and that are discarded when the printer is in a discard mode.

16. The apparatus of claim 14 wherein the commands received on the printer are carried over a bidirectional communication channel.

17. The apparatus of claim 14 wherein the instructions that determine if the one or more resources permit processing further includes instructions that determine if the printer processing the commands has sufficient amounts of resources selected from a set of one or more resources including: paper, toner, ink, storage, computational capacity, and communication bandwidth between the printer and a host.

18. The apparatus of claim 14 further comprising instructions that,
indicate to the host the last executed command before the printer enters into discard mode and begins to discard commands.

19. The apparatus of claim 14 further comprising instructions that,
download the discarded one or more commands from a buffer on the host to the printer to complete processing of the print request when the printer exits discard mode and enters non-discard mode.

20. The apparatus of claim 18 wherein the host transmits a protocol control command in response to the indication that the printer has entered into discard mode indicating the printer should exit discard mode and being processing the commands received instead of discarding the commands received.

21. An apparatus for a host to communicate with a printer, comprising:
a processor capable of executing instructions;
a memory containing instructions when executed on the processor cause the processor to buffer commands associated with a print request on the host, transmit commands associated with the print request to the printer for printing, receive indication that the printer is entering into a discard mode to maintain communication between the printer and the host when the printer determines one or more resources associated with the printer are not sufficient to process the commands associated with the print request; and resend the commands buffered on the host to the printer when the printer indicates it has exited discard mode and entered non-discard mode.

22. The apparatus of claim 21 wherein the transmitted commands include: protocol control commands used by the host and printer to control the communication between the host and printer using the protocol that are not discarded by the printer when in a discard mode, print commands used to accomplish the actual printing on the printer that are discarded when the printer is in a discard mode and printer control commands that affect how one or more features on the printer operates when printing and that are discarded when the printer is in a discard mode.

23. The apparatus of claim 21 wherein the commands are transmitted by the host over a bidirectional communication channel

24. The apparatus of claim 21 wherein the one or more resources associated with the printer are selected from a set of one or more resources including: paper, toner, ink, storage, computational capacity, and communication bandwidth between the printer and a host.

25. The apparatus of claim 21 wherein the host transmits a protocol control command in response to the indication that the printer has entered into discard mode, wherein the protocol control command indicates that the printer exit discard mode and process the commands transmitted instead of discarding the commands transmitted.

26. The apparatus of claim 21 wherein the instructions that resend the commands buffered on the host facilitates completing the print request.

27. An apparatus for a printer to communicate with a host device, comprising:
means for receiving commands compatible with a printer protocol from the host to be processed on the printer in association with a print request;
means for determining if one or more resources associated with the printer permit processing of the commands received from the host when the printer is in a non-discard mode;
means for entering the printer into a discard mode when the determination indicates the one or more resources associated with the printer are not available to permit processing of the commands and, unless one of the commands received is a protocol control command used by the host and printer to control the communication between the host and printer, discarding one or more of the commands to maintain communication between the printer and the host; and
means for exiting the printer from the discard mode and entering back into a non-discard mode when one of the commands received from the host is a protocol control command requesting that the printer exit discard mode.

28. An apparatus for a host to communicate with a printer, comprising:
means for buffering commands associated with a print request on the host;
means for transmitting commands associated with the print request to the printer for printing;
means for receiving indication that the printer is entering into a discard mode to maintain communication between the printer and the host when the printer determines one or more resources associated with the printer are not sufficient to process the commands associated with the print request; and
means for resending the commands buffered on the host to the printer when the printer indicates it has exited discard mode and entered non-discard mode.

29. A computer program product, tangibly stored on a computer-readable medium, for a printer to communicate with a host device, comprising instructions operable to cause a programmable processor to:
receive commands compatible with a printer protocol from the host to be processed on the printer in association with a print request;
determine if one or more resources associated with the printer permit processing of the commands received from the host when the printer is in a non-discard mode;
enter the printer into a discard mode when the determination indicates the one or more resources associated with the printer are not available to permit processing of the commands and, unless one of the commands received is a protocol control command used by the host and printer to control the communication between the host and printer, discarding one or more of the commands to maintain communication between the printer and the host; and
exit the printer from the discard mode and entering back into a non-discard mode when one of the commands received from the host is a protocol control command requesting that the printer exit discard mode.

30. A computer program product, tangibly stored on a computer-readable medium, for a host to communicate with a printer, comprising instructions operable to cause a programmable processor to:
buffer commands associated with a print request on the host;
transmit commands associated with the print request to the printer for printing;
receive indication that the printer is entering into a discard mode to maintain communication between the printer and the host when the printer determines one or more resources associated with the printer are not sufficient to process the commands associated with the print request; and
resend the commands buffered on the host to the printer when the printer indicates it has exited discard mode and entered non-discard mode.
